(19) United States
(12) Patent Application Publication
(10) Pub. No.: US 2012/0227314 A1
(43) Pub. Date: Sep. 13, 2012

(54) STEAM APPARATUS TO KILL ANTS

(76) Inventor: FU-TSENG LO, Zhongli City (TW)

(21) Appl. No.: 13/042,523

(22) Filed: Mar. 8, 2011

(51) Int. Cl. A01M 13/00; A01M 7/00

(52) U.S. Cl. 43/132.1

(57) ABSTRACT

A steam apparatus to kill ants includes a pipe member, a cover member and a steam generator. The pipe member can be filled with high-temperature steam to send steam through apertures disposed at the lower end of the pipe member. The steam generator is a gas-heating boiler and movable. The steam generator generates steam to be sent to the pipe member. When in use, the bottom end of the pipe member is inserted into an ant nest in the soil. The cover member encloses the surface of the soil, such that the steam from the steam generator is poured into the ant nest to kill the fire ants completely.

### BACKGROUND OF THE INVENTION

1. Field of the Invention

The present invention relates to a steam apparatus to kill ants, and more particularly, to a steam apparatus to kill fire ants.

2.Description of the Prior Art

Along with the development of traffic, importation and exportation of various goods, fire ants are transported to different countries which never have fire ants. According to a research, fire ants are a polyphagous animal and may jeopardize earthworms in some damaged areas. Fire ants also eat babies of mammals, birds or reptiles, which cause reduction of some species to influence ecological distribution. Besides, fire ants also eat fruits, stems and leaves of crops to cause great damage. The livestock industry also fears fire ants. If a sensitive person is bit by a fire ant, he/she may go into an anaphylactic shock or die.

In the past, to kill fire ants consumed a lot of money and didn't get an ideal effect. In particular, chemistry pesticide is used to kill fire ants, which is harm to agriculture environments, ecological environments and human health.

Another way to kill fire ants is to put poison bait. Because ant eggs or ant pupas are at the lower portion of an ant nest, they won't eat the poison bait. This way is not perfect. In addition, the poison bait is placed in the soil, which may be affected with damp or go bad. The effect to kill fire ants is lowered. Furthermore, the bait is poison, which will be harmful to the environments.

Nowadays, many crops are labeled non-poison and organic crops. How to kill fire ants in a harmless way is a topic for study or discussion.

Accordingly, the inventor of the present invention thinks the best way to kill fire ants is to use high-temperature steam. This way is harmless to the environments and complies with the demand of environment protection. So far, there is no steam apparatus used to kill fire ants. The inventor of the present invention invents the steam apparatus for the need to kill fire ants.

The present invention provides a prevention and cure approach to kill fire ants quickly without poison and harm.

### SUMMARY OF THE INVENTION

The primary object of the present invention is to provide a steam apparatus to kill fire ants.

The steam apparatus to kill ants can generate high-temperature steam to be guided into an ant nest in the soil so as to kill the ants.

The steam apparatus to kill ants comprises a pipe member, a cover member and a steam generator.

The pipe member is used to guide high-temperature steam. The bottom end of the pipe member has a plurality of apertures thereon so as to send the steam out. The pipe member has an annular rib thereon.

The cover member is slidable on the pipe member.

The steam generator is a gas-heating boiler which outputs steam by heating water with gas fuel. The steam generator may be placed on a man-powered vehicle or a power vehicle so as to move the steam generator. The steam generator comprises a water storage unit which is a cylinder to store water, a heating unit and a temperature control unit. The temperature control unit is adapted to control the heating unit. The heating unit is adapted to heat the water in the water storage unit.

When in use, the steam generator generates steam which is sent to the pipe member. The bottom end of the pipe member is inserted into an ant nest in the soil. The cover member encloses the surface of the soil, such that the steam from the steam generator is poured into the ant nest to kill the fire ants completely.

### BRIEF DESCRIPTION OF THE DRAWINGS

FIG. 1 is a perspective view according to a preferred embodiment of the present invention;

FIG. 2 is a schematic view according to the preferred embodiment of the present invention when in use; and

FIG. 3 is another schematic view according to the preferred embodiment of the present invention when in use.

### DETAILED DESCRIPTION OF THE PREFERRED EMBODIMENTS

Embodiments of the present invention will now be described, by way of example only, with reference to the accompanying drawings.

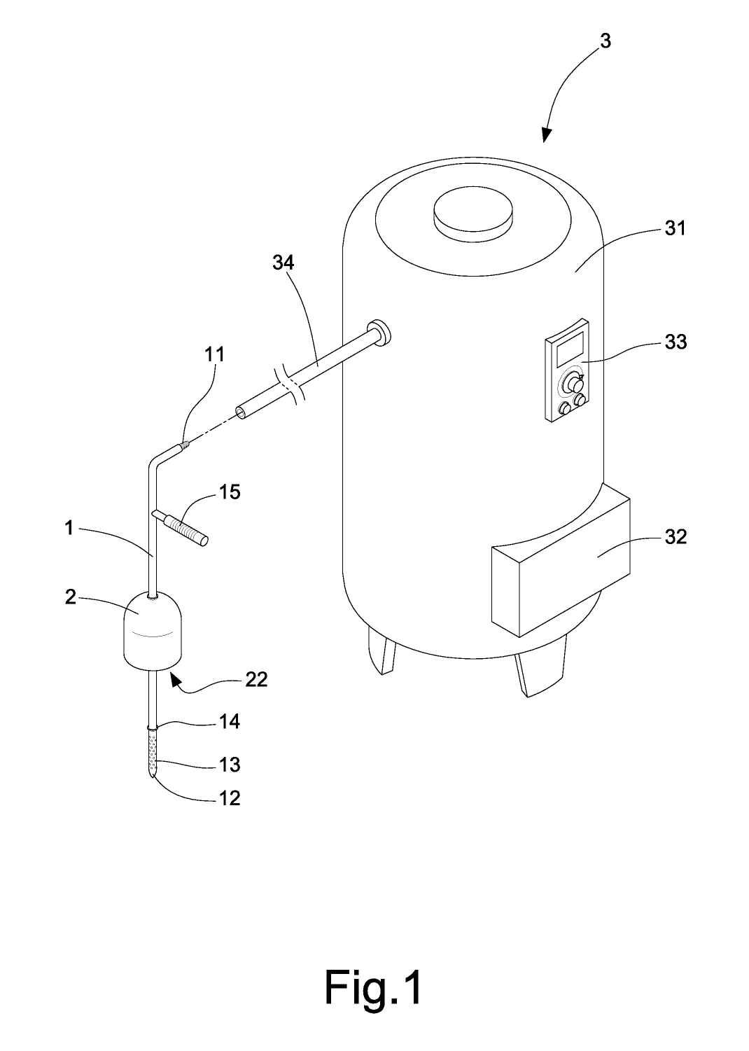

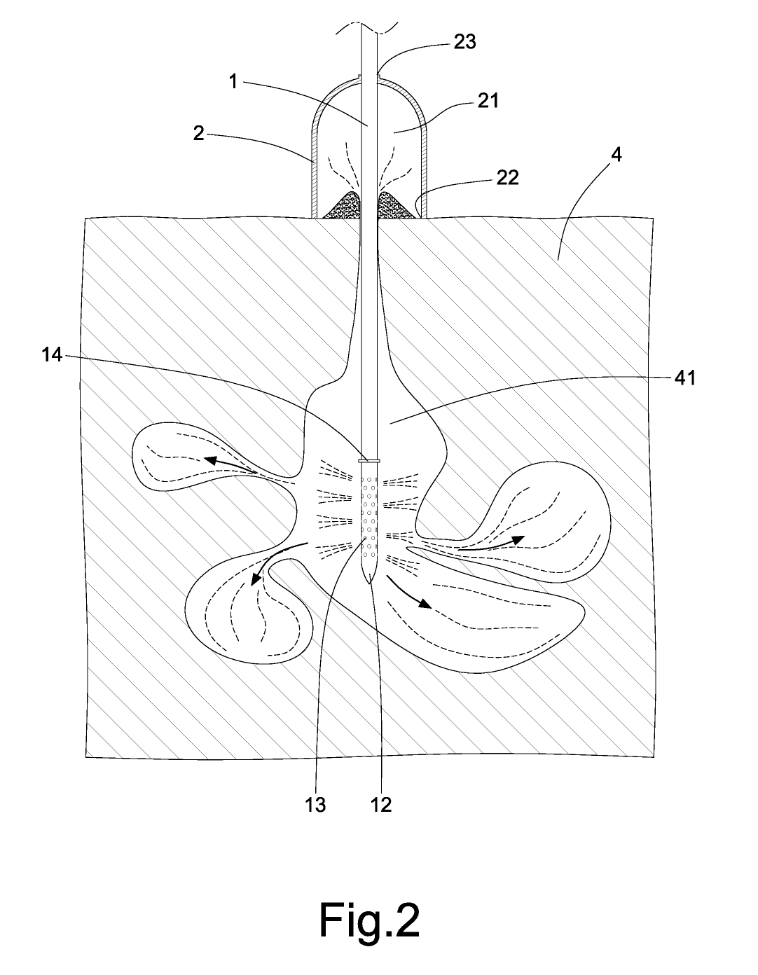

As shown in FIG. 1 and FIG. 2, a steam apparatus to kill ants according to a preferred embodiment of the present invention comprises a pipe member 1, a cover member 2, and a steam generator 3.

The pipe member 1 is a hollow pipe. The pipe member 1 has an inlet end 11 connected to the steam generator 3 and a bottom end 12 opposite the inlet end 11. The bottom end 12 is a pointed end so as to be inserted into the soil 4. The bottom end 12 has a plurality of apertures 13 thereon. The apertures 13 communicate with the inside of the pipe member 1. The pipe member 1 further has an annular rib 14 disposed on the pipe member 1.

The cover member 2 has a room 21 therein, an open lower end 22, and an opening 23 for insertion of the pipe member 1.

The steam generator 3 is a gas-heating boiler which outputs steam by heating water with gas fuel. The steam generator 3 may be placed on a man-powered vehicle or a power vehicle (not shown in the drawings) so as to move the steam generator 3. The steam generator 3 comprises a water storage unit 31 which is a cylinder to store water, a heating unit 32 and a temperature control unit 33. The temperature control unit 33 is used to control the heating unit 32. The heating unit 32 is used to heat the water in the water storage unit 31. The temperature control unit 33 may have a manual setting function and an automatic setting function. When the steam is sufficient, the temperature control unit 33 will temporarily stop the heating unit 32 from heating. On the contrary, when the steam is not sufficient, the temperature control unit 33 will start the heating unit 32 to heat the water. In this way, the volume of the steam can be controlled well, without wasting water. The water storage unit 31 is connected with a pip 34 to output the steam, and the pipe 34 is connected to the inlet end 11 of the pipe member 1.

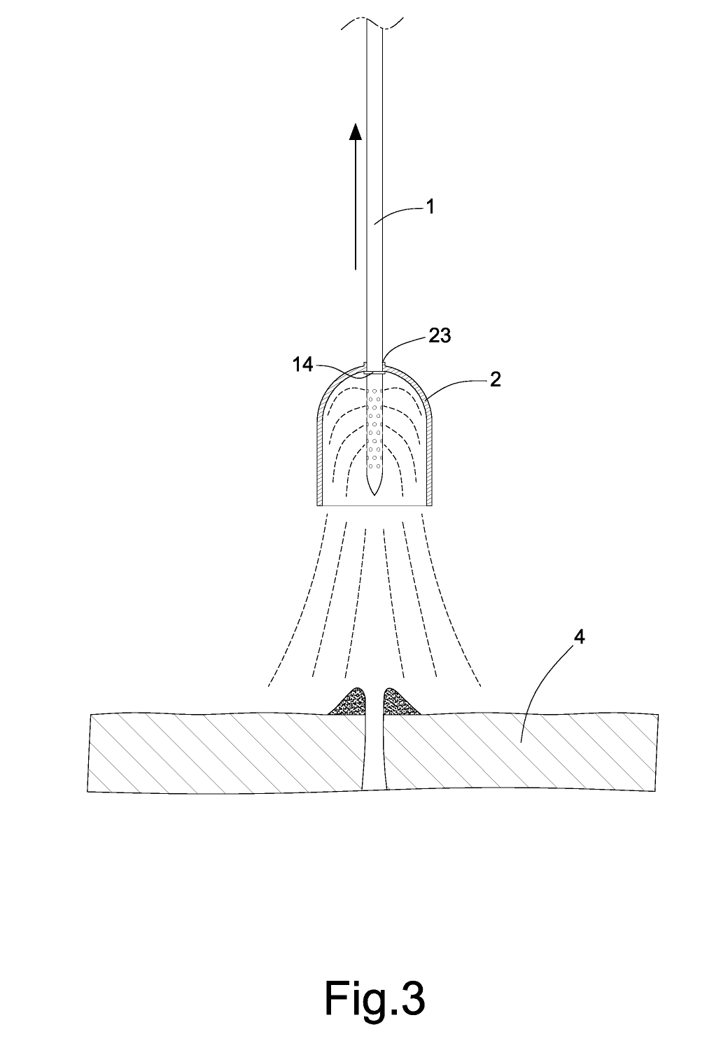

When in use as shown in FIG. 2, the bottom end 12 of the pipe member 1 is inserted into an ant nest 41 in the soil 4, and then the cover member 2 covers the surface of the soil 4 completely to enclose the ant nest 41. The steam generator 3 is started to generate steam which is outputted through the pipe 34 of the water storage unit 31 and then guided into the pipe member 1 through the inlet end 11 and then sent out from the apertures 13. The high-temperature steam is spread in the ant nest 41. After a period of time, the fire ants in the ant nest 41 will be killed. After that, the pipe member 1 is pulled out. For the reason of safety, the cover member 2 is still placed on the surface of the soil 4 and the steam generator 3 continues to provide steam. As show in FIG. 3, when the pipe member 1 is pulled upward, the annular rib 14 will be in contact with the cover member 2. In case there are fire ants in the cover member 2 or the bottom of the pipe member 1, there is no gap between the cover member 2 and the pipe member 1 through the configuration of the annular rib 14. The steam generator 3 continues to provide steam so as to kill the fire ants in the cover member 2 completely.

It is not easy to kill fire ants completely. If there is a survivor, such as an ant queen or few ants, it will nest a new ant nest quickly. The annular rib 14 of the present invention is to ensure all the fire ants to be killed completely.

The pipe member 1 further has a handle 15 at a side thereof for the user to grasp.

The steam generator 3 uses a gas-heating boiler to be placed on a man-powered vehicle or a power vehicle, which is movable to enhance its mobility. The steam generator 3 may be an electric heating device incorporated with a generator to generate steam.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A steam apparatus to kill ants, comprising:
a pipe member, the pipe member being a hollow pipe, the pipe member having an inlet end and a bottom end opposite the inlet end, the bottom end having a plurality of apertures thereon, the apertures communicating with the inside of the pipe member;
a cover member, the cover member having a room therein, an open lower end and an opening for insertion of the pipe member; and
a steam generator for generating steam to be sent the pipe member.

2. The steam apparatus to kill ants as claimed in claim 1, wherein the pipe member further has an annular rib thereon.

3. The steam apparatus to kill ants as claimed in claim 1, wherein the bottom end of the pipe member is a pointed end.

4. The steam apparatus to kill ants as claimed in claim 1, wherein the steam generator is a gas-heating boiler or an electric heating device.

5. The steam apparatus to kill ants as claimed in claim 1, wherein the steam generator is placed on a man-powered vehicle or a power vehicle.

6. The steam apparatus to kill ants as claimed in claim 1, wherein the steam generator comprises a water storage unit which is a cylinder to store water, a heating unit and a temperature control unit, the temperature control unit being adapted to control the heating unit, the heating unit being adapted to heat the water in the water storage unit.
